(19) United States
(12) Patent Application Publication
(10) Pub. No.: US 2013/0311072 A1
(43) Pub. Date: Nov. 21, 2013

(54) POWER-STEERING CONTROL SYSTEM

(71) Applicant: SUZUKI MOTOR CORPORATION, Shizuoka (JP)

(72) Inventors: Seiji TOCHIHARA, Shizuoka (JP); Makoto KOIWAI, Shizuoka (JP)

(73) Assignee: SUZUKI MOTOR CORPORATION, Shizuoka (JP)

(21) Appl. No.: 13/889,446

(22) Filed: May 8, 2013

(30) Foreign Application Priority Data
May 21, 2012 (JP) 2012-115544

(51) Int. Cl. F02D 45/00

(52) U.S. Cl. CPC F02D 45/00
USPC 701/112

(57) ABSTRACT

In a power-steering control system installed in a vehicle, a state determiner determines whether an engine is in a state in which the engine is stopped. A steering-torque detector measures steering torque applied to a steering wheel by a driver of the vehicle. A controller holds the power steering motor in a ready state to generate the assist torque if it is determined that the engine is in the stop state and that the measured steering torque is equal to or higher than first threshold torque.

### CROSS REFERENCE TO RELATED APPLICATIONS

This application is based on and claims the benefit of priority from Japanese Patent Application No. 2012-115544, filed on May 21, 2012, the disclosure of which is incorporated in its entirety by reference.

### TECHNICAL FIELD

The present invention relates to power-steering control systems for controlling a motor for generating torque to assist the driver's turning effort of a steering wheel of a vehicle; this torque will be referred to as assist torque.

### BACKGROUND

In recent motor vehicles, idle-reduction control systems are used in addition to such power-steering control systems in order to reduce fuel cost, exhaust emission, and the like. In such a motor vehicle, a power-steering control system deactivates a motor, referred to as a power-steering motor, for generating assist torque if it deter mines that a condition for shifting the operation mode of an engine to an idle-reduction mode is met, and that the engine operates in the idle-reduction mode. The condition will be referred to as an idle-reduction mode shift condition hereinafter. Specifically, the power-steering control system determines that the idle-reduction mode shift condition is met when receiving an idle-reduction signal from the idle-reduction control system. The idle-reduction signal is sent from the idle-reduction control system to the power-steering control system if it determines that the idle-reduction mode shift condition is met. The power-steering control system determines that the engine operates in the idle-reduction mode when the engine speed becomes lower than a preset value.

The power-steering control system measures driver's steering torque applied to the steering wheel, and sends the measured steering torque to the idle-reduction control system. During the engine operating in the idle-reduction mode, the idle-reduction control system generates an engine restart request if it determines that the measured steering torque is equal to or higher than preset torque α, and restarts the engine in response to the generation of the engine restart request. The preset torque α serves as threshold torque for determination of whether to restart the engine.

In addition, Japanese Patent Application Publication No. 2001-106107 discloses a power-steering control system that gradually reduces assist torque when an engine operates in an idle-reduction mode.

### SUMMARY

Until rotation of the engine is completely stopped during the engine operating in the idle-reduction mode, the idle-reduction control system generates an engine restart request when the measured steering torque is equal to or higher than the preset torque α. However, because it may be difficult for idle-reduction control system to restart the engine until rotation of the engine is completely stopped, the idle-reduction control system restarts the engine based on the engine restart request after rotation of the engine is completely stopped. In this case, the power-steering motor is switched from an on state to an off state when the engine speed becomes lower than the preset value. Thereafter, the power-steering motor is switched from the off state to the on state when the engine is restarted after complete stop of rotation of the engine.

As described above, if an engine restart request is generated until rotation of the engine is completely stopped, the power-steering motor is switched from the on state to the off state, and thereafter switched from the off state to the on state. This frequent on/off switching of the power-steering motor may result in bad steering feeling. For example, a driver of the vehicle may feel a little resistance in turning the steering wheel.

On the other hand, if the power-steering control system controlled the power-steering motor to be continuously activated during the engine operating in the idle-reduction mode, the driver's steering feeling could be kept comfortable.

However, this control could generate assist torque when the measured steering torque reached the preset torque α so that the engine was restarted. Thus, a steering angle of the steering wheel based on this control could be larger than that of the steering wheel based on the aforementioned control that deactivates the power-steering motor upon the engine operating in the idle-reduction mode. For this reason, a driver of the vehicle could need to turn the steering wheel by a steering angle larger than a driver's intended steering angle in order to restart the engine, resulting in difficulty for the driver to restart the engine by the driver's operation of the steering wheel.

In addition, the power-steering control system disclosed in the Patent Publication No. 2001-106107 is configured to restart an engine when the measured steering torque of a steering wheel becomes a preset value while the assist torque is gradually reduced.

However, in the power-steering control system disclosed in the Patent Publication No. 2001-106107, a steering angle of the steering wheel at which the steering torque becomes the preset value may vary for every restart of the engine, bringing a feeling of strangeness to a driver of the vehicle for every restart of the engine.

In view of the circumstances set forth above, one aspect of the present invention seeks to provide power-steering control systems of vehicles designed to address the problems set forth above.

Specifically, an alternative aspect of the present invention aims to provide such power-steering control systems, each of which is capable of keeping good steering feeling even if an engine restart request occurs during an engine operating in an idle-reduction mode.

According to an exemplary aspect of the present invention, there is provided a power-steering control system, installed in a vehicle, for controlling a power-steering motor that generates assist torque for assisting driver's turning effort of a steering wheel of the vehicle. The vehicle is designed to perform idle-reduction control to: stop an engine for generating drive power for the vehicle if a predetermined stop condition is met; and restart the stopped engine if a predetermined restart condition is met. The power-steering control system includes a state determiner configured to determine whether the engine is in a state in which the engine is stopped. The power-steering control system includes a steering-torque detector configured to measure steering torque applied to the steering wheel by a driver of the vehicle. The power-steering control system includes a controller configured to hold the power-steering motor in a ready state to generate the assist torque if it is determined that the engine is in the stop state and that the measured steering torque is equal to or higher than first threshold torque.

In a first example of the exemplary aspect of the present invention, the engine restart condition includes a condition representing that the measured steering torque is equal to or higher than predetermined second threshold torque. The controller is configured to: deactivate the power steering motor upon a first determination that the engine is in the stop state and that the measured steering torque is lower than the first threshold torque; then hold a deactivated state of the power-steering motor until the engine is restarted even upon a second determination that the engine is in the stop state and that the measured steering torque is equal to or higher than the first threshold torque.

In a second example of the exemplary aspect of the present invention, the first threshold torque is identical to the second threshold torque.

The power-steering control system according to the exemplary aspect of the present invention holds the power-steering motor in the ready state to generate the assist torque if it is determined that the engine is in the stop state and that the measured steering torque is equal to or higher than the first threshold torque. Thus, even if an engine restart condition is met during the engine being in the stop state, it is possible to keep good steering feeling.

In the first example of the exemplary aspect, the engine restart condition includes a condition representing that the measured steering torque is equal to or higher than predetermined second threshold torque. The controller is configured to: deactivate the power steering motor upon the first determination that the engine is in the stop state and that the measured steering torque is lower than the first threshold torque; then hold the deactivated state of the power-steering motor until the engine is restarted even upon the second determination that the engine is in the stop state and that the measured steering torque is equal to or higher than the first threshold torque. Thus, it is possible to prevent a steering angle of the steering wheel for restarting the engine from being larger than a driver's intended steering angle, thus reducing variations in the steering angle of the steering wheel turned by a driver for restarting the engine.

In the second example of the exemplary aspect of the present invention, because the first threshold torque is identical to the second threshold torque, it is possible to restart the engine during the engine in the stop state a driver turns the steering wheel by a constant angle corresponding to the second threshold torque identical to the first threshold torque.

### BRIEF DESCRIPTION OF THE DRAWINGS

Other aspects of the present invention will become apparent from the following description of embodiments with reference to the accompanying drawings in which:

FIG. 1 is a view schematically illustrating a structural example of a power-steering control system installed in a vehicle according to an embodiment of the present invention; and

FIG. 2 is a flowchart schematically illustrating a routine carried out by an ECU (Electronic Control Unit) illustrated in FIG. 1.

### DETAILED DESCRIPTION OF EMBODIMENT

An embodiment of the present invention will be described hereinafter with reference to the accompanying drawings.

In this embodiment, a power-steering control system 1 installed in a vehicle will be described.

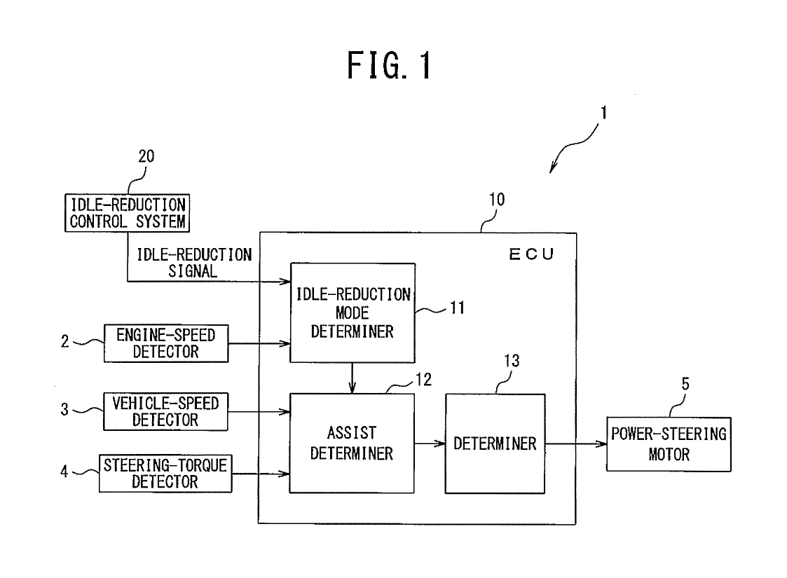

FIG. 1 schematically illustrates a structural example of the power-steering control system 1.

Referring to FIG. 1, the power-steering control system 1 includes an engine-speed detector 2, a vehicle-speed detector 3, a steering-torque detector 4, an ECU (Electronic Control Unit) 10, and a power-steering motor 5. Each of the components 2, 3, 4, and 5 is communicably connected to the ECU 10.

The engine-speed detector 2 is operative to measure the speed of an engine, and output a signal indicative of the measured engine speed to the ECU 10. The engine is operative to generate drive power for the vehicle.

The vehicle-speed detector 3 is operative to measure the speed of the vehicle, and output a signal indicative of the measured vehicle speed to the ECU 10.

The steering-torque detector 4 is operative to measure steering torque applied to a steering wheel of the vehicle, and output a signal indicative of the measured steering torque to the ECU 10.

The ECU 10 for example includes a microcomputer and its peripherals. Specifically, the ECU 10 is comprised of a CPU, a ROM, a RAM, and so on. In the ROM, one or more programs are stored; the one or more programs cause the CPU to perform the various tasks using the RAM.

The ECU 10 is operative to perform various tasks for controlling power-steering for a driver of the vehicle. In this embodiment, the ECU 10 is operative to control the power-steering motor 5 as a function of the signals outputted from the detectors 2 to 4 and an idle-reduction signal inputted thereto. For example, the idle-reduction signal is sent from an idle-reduction control system 20 to the ECU 10 if it is determined that a condition for shifting the operation mode of the engine to an idle-reduction mode is met. The condition will be referred to as an idle-reduction mode shift condition hereinafter.

For example, if the idle-reduction mode shift condition is met, the idle-reduction control system 20 shuts off the supply of fuel to the compression chambers of the engine, thus automatically stopping the engine. In addition, if a predetermined engine restart condition is met, the idle-reduction control system 20 controls, for example, a starter of the vehicle to crank the stopped engine, thus restarting the engine.

Specifically, the ECU 10 functionally includes an idle-reduction mode determiner 11, an assist determiner 12, and a determiner 13 for determining whether to enable activation of the power-steering motor 5.

To the idle-reduction mode determiner 11, the idle-reduction signal outputted from the idle-reduction control system 20 and the signal indicative of the measured engine speed outputted from the engine-speed detector 2 are inputted. The idle-reduction mode determiner 11 is operative to determine whether the engine operates in an idle-reduction mode based on the idle-reduction signal and the measured engine speed.

To the assist determiner 12, the signal indicative of the measured vehicle speed outputted from the vehicle speed detector 3 and the signal indicative of the measured steering torque outputted from the steering-torque detector 4 are inputted. In addition, to the assist determiner 12, info information indicative of results of the determination by the idle-reduction mode determiner 11 is inputted. The assist determiner 12 is operative to deter mine whether to generate assist torque for assisting the driver's turning effort of the steering wheel based on the measured vehicle speed, the measured steering torque, and the results of the determination by the idle-reduction mode determiner 11.

To the determiner 13, information indicative of results of the determination by the assist determiner 12 is inputted. The determiner 13 is operative to control the operational state, such as the ready state and the deactivated state, of the power-steering motor 5 based on the results of the determination by the assist torque determiner 12.

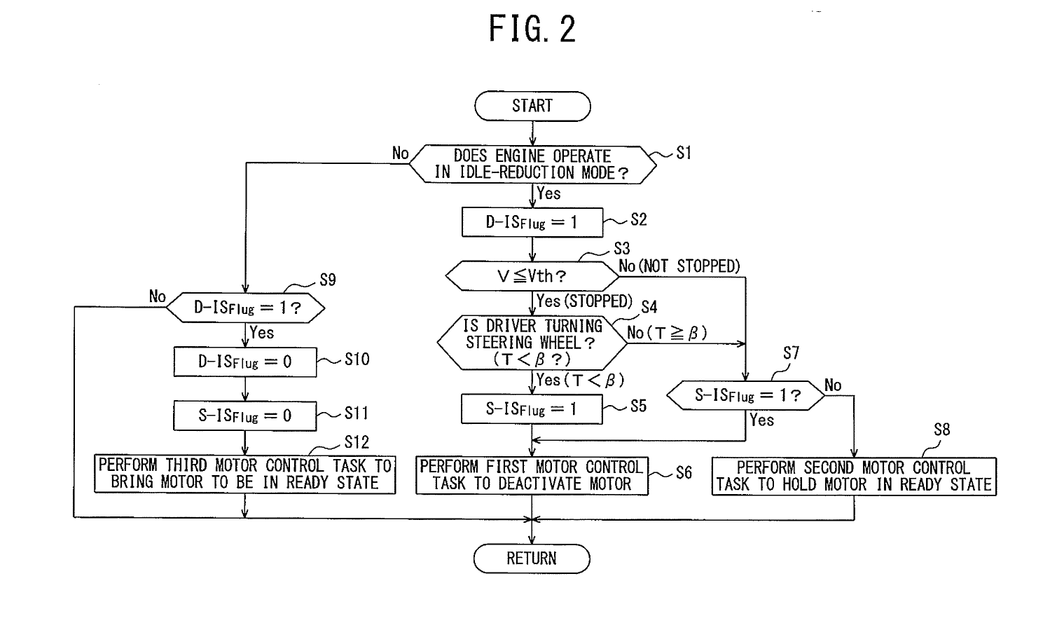

FIG. 2 schematically illustrates a routine carried out by the ECU 10 configures set forth above. Specific operations of the respective functional modules 11 to 13 of the ECU 10 will be described with reference to the procedure illustrated in FIG. 2. Note that the ECU 10 is programmed to execute the routine illustrated in FIG. 2 every given cycle.

Referring to FIG. 2, the idle-reduction mode determiner 11 determines whether the engine operates in the idle-reduction mode in step S1. Specifically, the idle-reduction mode determiner 11 determines that the engine operates in the idle-reduction mode if the measured engine speed is lower than a threshold value and it has received the idle-reduction signal. The threshold value for the engine speed is previously determined experimentally, empirically, and/or theoretically. For example, the threshold value is set to 220 rpm. Upon determination that the engine operates in the idle-reduction mode, the routine illustrated in FIG. 2 proceeds to step S2. Otherwise, upon determination that the engine does not operate in the idle-reduction mode, the routine illustrated in FIG. 2 proceeds to step S9.

In step S2, because the idle stop control is being executed, the assist determiner 12 assigns 1 to an idle-reduction execution flag D-IS_{Flag} that represents whether idle-reduction control has been being executed or not. Thus, the idle-reduction execution flag D-IS_{Flag} is given by D-IS_{Flag}=1.

Next, in step S3, the assist determiner 12 determines whether the measured vehicle speed V is equal to or lower than a threshold speed Vₜₕ. Note that the threshold speed Vₜₕ is a threshold speed representing whether the vehicle is stopped or not. For example, the threshold speed Vₜₕ is previously determined experimentally, empirically, and/or theoretically.

Upon determination that the measured vehicle speed V is equal to or lower than the threshold speed Vₜₕ, which is given by V≦Vₜₕ, the routine proceeds to step S4. Otherwise, upon determination that the measured vehicle speed V is higher than the threshold speed Vₜₕ, which is given by V>Vₜₕ, the routine proceeds to step S7.

In step S4, the assist determiner 12 deter mines whether a driver of the vehicle is turning the steering wheel. Specifically, the assist determiner 12 determines whether the measured steering torque T is lower than threshold torque β in step S4. The threshold torque β is torque representing whether the ECU 10 holds the power-steering motor 5 in a ready state. For example, the threshold torque β is previously determined experimentally, empirically, and/or theoretically. If the power-steering motor 5 is held in the ready state, the power-steering motor 5 is immediately activated to generate assist torque in response to when a driver turns the steering wheel. In other words, when the power-steering motor 5 is energized, the power-steering motor 5 is shifted to the ready state, and while the power-steering motor 5 is kept to be energized, the power-steering motor 5 is held in the ready state.

Upon determination that the measured steering torque T is lower than the threshold torque β(T<β), the assist determiner 12 determines that the driver is not turning the steering wheel. The routine proceeds to step S5. Otherwise, upon determination that the measured steering torque T is equal to or higher than the threshold torque β(T≧β), the routine proceeds to step S7.

In step S5, the assist determiner 12 assigns 1 to a steering flag S-IS_{Flag}, given by S-IS_{Flag}=1; the steering flag S-IS_{Flag} represents whether a driver has stopped turning of the steering wheel. That is, 1 assigned to the steering flag S-IS_{Flag} represents that a driver has stopped turning of the steering wheel during idle-reduction control. Thereafter, the routine proceeds to step S6.

In step S7, the assist determiner 12 determines whether the steering flag S-IS_{Flag} is set to 1. Upon determination that the steering flag S-IS_{Flag} is set to 1, the assist determiner 12 determines that a driver has stopped turning of the steering wheel during idle-reduction control. Then, the routine proceeds to step S6. Otherwise, upon determination that the steering flag S-IS_{Flag} is unset to 1, i.e. set to 0, the assist determiner 12 determines that a driver continues turning of the steering wheel during idle-reduction control. Then, the routine proceeds to step S8.

In step S6, the determiner 13 performs a first motor control task, and the ECU 10 terminates the routine illustrated in FIG. 2. The first motor control task is to stop the holding of the power-steering motor 5 in the ready state, that is, to de-energize the power-steering motor 5.

In step S8, the determiner 13 performs a second motor control task, and the ECU 10 terminates the routine illustrated in FIG. 2.

The second motor control task is to hold the power-steering motor 5 in the ready state, that is, to keep energization of the power-steering motor 5. The second motor control task causes the power-steering motor 5 to be continuously held in the ready state before and during execution of the idle-reduction control.

On the other hand, in step S9, the assist determiner 12 determines whether the idle-reduction execution flag D-IS_{Flag} is set to 1. Upon determination that the idle-reduction execution flag D-IS_{Flag} is set to 1, the assist determiner 12 determines that the idle-reduction control was executed, or the idle-reduction control has been stopped. This is because the determination in step S1 is negative. Then, the routine proceeds to step S10.

Otherwise, upon determination that the idle-reduction execution flag D-IS_{Flag} is unset to 1, i.e. set to 0, the assist determiner 12 terminates the routine illustrated in FIG. 2.

In step S10, the assist determiner 12 assigns 0 to the idle-reduction execution flag D-IS_{Flag}, thus resetting it to zero. Next, in step S11, the assist determiner 12 assigns 0 to the steering flag S-IS_{Flag}, thus resetting it to zero.

Next, in step S12, the determiner 13 performs a third motor control task, and the ECU 10 terminates the routine illustrated in FIG. 2.

The third motor control task is to bring the power-steering motor 5 to be in the ready state.

Next, operations of the power-steering control system 1 will be described hereinafter.

The power-steering control system 1 performs the first motor control task to stop the holding of the power steering motor in the ready state (see step S6), provided that:

the engine operates in the idle-reduction mode, i.e. the determination in step S1 is affirmative;

the vehicle is stopped, i.e. the measured vehicle speed V is equal to or lower than the threshold speed Vₜₕ (YES in step S3); and
the driver is not turning the steering wheel, i.e. the measured steering torque T is lower than the threshold torque β (YES in step S4).

The power-steering control system 1 determines whether a driver has stopped turning of the steering wheel during idle-reduction control (see step S7), provided that:

the engine operates in the idle-reduction mode, i.e. the determination in step S1 is affirmative; and the vehicle is not stopped, i.e. the measured vehicle speed V is higher than the threshold speed Vₜₕ (NO in step S3).

When it is determined that the driver continues turning of the steering wheel during idle-reduction control, i.e. the steering flag S-IS_{Flag} is set to 0 (NO in step S7), the power-steering control system 1 performs the second motor control task to hold the power steering motor in the ready state (see step S8).

In other words, the power-steering control system 1 performs the second motor control task that holds the power steering motor in the ready state to thereby generate assist torque, provided that:

the engine operates in the idle-reduction mode, i.e. the determination in step S1 is affirmative; and

the measured steering torque T is kept to be equal to or higher than the threshold torque β (NO in step S4 and NO in step S7).

When it is determined that a driver has stopped turning of the steering wheel during idle-reduction control (see YES in step S4), the power-steering control system 1 performs the first motor control task to hold the stop state of the power-steering motor 5 (see step S6) even if the driver turns the steering wheel after the determination. This is because the determination in step S7 is affirmative even if the determination in step S4 is negative.

When it is determined that the engine does not operate in the idle-reduction mode, i.e. the determination in step S1 is negative, the power-steering control system 1 performs the third motor control task to hold the power-steering motor 5 in the ready state (see step S12), provided that:

the assist determiner 12 determines that the idle-reduction control was executed by the idle-reduction control system 20 in the previous execution of the routine, i.e. the D-IS_{Flag} is set to 0 (see YES in step S9).

Specifically, the relationship between the third motor control task and the first motor control task shows that, if a driver has stopped turning of the steering wheel during idle-reduction control, the power-steering control system 1 is configured to hold the stop state of the power-steering motor 5. For this reason, the power-steering control system 1 prevents generation of assist torque until the operation mode of the engine is shifted from the idle-reduction mode to another mode, such as a normal running mode.

As described above, the power-steering control system 1 performs the second motor control task to hold the power steering motor in the ready state, provided that the measured steering torque T applied to the steering wheel by a driver is continuously kept to be equal to or higher than the threshold torque β during idle-reduction control (see step S8).

For this reason, even if there is an engine restart request upon a measured value of the steering torque being equal to or higher than preset torque α during idle-reduction control, the power-steering control system 1 holds the power-steering motor 5 in the ready state, provided that the measured steering torque T is continuously kept to be equal to or higher than the threshold torque β during idle-reduction control. This prevents the power-steering motor 5 from being switched from the on state to the off state, and then back to the on state during idle-reduction control, making it possible to keep good steering feeling. Note that the threshold torque β should be set to be equal to or lower than the preset torque α, given by β≦α.

On the other hand, when the measured steering torque T becomes lower than the threshold torque β, the power-steering control system 1 performs the first motor control task to deactivate the power-steering motor 5 (see step S6).

Even if the measured steering torque T became equal to or higher than the threshold torque β after the deactivation of the power-steering motor 5, the power-steering control system 1 holds the deactivated state of the power-steering motor 5 until the engine is restarted, i.e. the engine is shifted from the idle-reduction mode to another mode (see step S6). This is because the measured steering torque T became lower than the threshold torque β, so that the determination in step S7 is affirmative.

Thus, the threshold torque β can be set to be equal to or higher than the preset torque α, given by β≧α. In contrast, for keeping good steering feeling, the threshold torque β can be set to be equal to or lower than the preset torque α, given by β≦α. Based on the characteristics of the threshold torque β and the preset torque α, the threshold torque β can be set to be equal to the preset torque α, given by β=α.

For this reason, it is possible to deactivate the power-steering motor 5 as soon as possible during idle-reduction control except for limited circumstances where the engine is restarted immediately after the operation mode of the engine is shifted to the idle-reduction mode. Thus, it is possible to prevent a steering angle of the steering wheel for restarting the engine from being larger than a driver's intended steering angle, thus reducing variations in the steering angle of the steering wheel turned by a driver for restarting the engine.

As described above, the power-steering control system 1 is configured to determine how the operational state of the power-steering motor 5 based on measured values of the steering torque T during idle-reduction control. Thus, even if the power-steering system 1 cannot restart the engine due to the occurrence of an engine restart request during idle-reduction control, it can hold the power-steering motor 5 in the ready state, thus keeping good steering feeling.

The power-steering control system 1 deactivates the power-steering motor 5 as soon as possible during idle-reduction control except for limited circumstances where the engine is restarted immediately after the operation mode of the engine is shifted to the idle-reduction mode. Thus, it is possible to prevent a steering angle of the steering wheel for restarting the engine from being larger than a driver's intended steering angle, thus reducing variations in the steering angle of the steering wheel turned by a driver for restarting the engine.

The power-steering control system 1 is configured to control activation of the power-steering motor 5 without specific components, thus achieving the aforementioned effects without cost increase.

The power-steering control system 1 can be configured to selectively perform the first motor control task and the second motor control task using a common logic with different constant values.

Note that, in this embodiment, the idle-reduction mode determiner 11 serves as, for example, a state determiner configured to determine whether the engine is in a state in which the engine is stopped. The steering-torque detector 4 is configured to measure steering torque applied to the steering wheel by a driver of the vehicle. The assist determiner 12 and the determiner 13 serve as, for example, a controller configured to hold a power-steering motor in a ready state to generate assist torque if it is determined that the engine is in the state and that the measured steering torque is equal to or higher than first threshold torque. The threshold torque β serves as, for example, the first threshold torque, and the preset torque α serves as, for example, second threshold torque used as a parameter of an engine restart condition.

In this embodiment, in step S3, the assist determiner 12 can determine whether the vehicle is decelerated by monitoring the variation in the measured vehicle speed. Upon determination that the vehicle is decelerated (YES in step S3), the routine illustrated in FIG. 2 proceeds to step S4. Otherwise, upon determination that the vehicle is not decelerated (NO in step S3), the routine proceeds to step S7. Thus, the power-steering control system 1 according to a modification of this embodiment can control the operational state of the power-steering motor 5 while the vehicle speed is decelerated based on idle-reduction control.

While an illustrative embodiment of the present disclosure has been described herein, the present disclosure is not limited to the embodiment described herein, but includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

What is claimed is:

1. A power-steering control system, installed in a vehicle, for controlling a power-steering motor that generates assist torque for assisting driver's turning effort of a steering wheel of the vehicle, the vehicle being designed to perform idle-reduction control to: stop an engine for generating drive power for the vehicle if a predetermined stop condition is met; and
restart the stopped engine if a predetermined restart condition is met, the power-steering control system comprising:
a state determiner configured to determine whether the engine is in a state in which the engine is stopped;
a steering-torque detector configured to measure steering torque applied to the steering wheel by a driver of the vehicle; and
a controller configured to hold the power-steering motor in a ready state to generate the assist torque if it is determined that the engine is in the stop state and that the measured steering torque is equal to or higher than first threshold torque.

2. The power-steering control system according to claim 1, wherein the engine restart condition includes a condition representing that the measured steering torque is equal to or higher than predetermined second threshold torque, and
the controller is configured to:
deactivate the power steering motor upon a first determination that the engine is in the stop state and that the measured steering torque is lower than the first threshold torque; then
hold a deactivated state of the power-steering motor until the engine is restarted even upon a second determination that the engine is in the stop state and that the measured steering torque is equal to or higher than the first threshold torque.

3. The power-steering control system according to claim 2, wherein the first threshold torque is identical to the second threshold torque.
